(19) United States
(12) Patent Application Publication
(10) Pub. No.: US 2005/0097768 A1
(43) Pub. Date: May 12, 2005

(54) Apparatus and method for drying gloves and boots

(76) Inventors: John T. Burns SR., Manito, IL (US); John T. Burns JR., Pekin, IL (US)

Correspondence Address: HUSCH & EPPENBERGER, LLC, 190 CARONDELET PLAZA, SUITE 600, ST. LOUIS, MO, 63105-3441, US

(21) Appl. No.: 10/974,085

(22) Filed: Oct. 27, 2004

Related U.S. Application Data
(60) Provisional application No. 60/518,219, filed on Nov. 7, 2003.

(51) Int. Cl. F26B 19/00

(52) U.S. Cl. 34/90

(57) ABSTRACT

An apparatus for drying gloves and boots is disclosed. The apparatus includes a pipe, a fan, a plurality of first tubes connected to the pipe and a plurality of second tubes connected to the first tubes. Also disclosed is a method of assembling an apparatus for drying gloves and boots.

### CROSS-REFERENCE TO RELATED APPLICATIONS

This application claims priority of U.S. provisional application Ser. No. 60/518,219, filed on Nov. 7, 2003.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to drying devices and, more particularly, to an apparatus for drying gloves and boots.

2. Related Art

A firefighter must wear gloves and boots in the performance of his or her duties. While performing his or her duties, the gloves and/or boots frequently get wet. A firefighter must wear gloves and boots even if they are wet. Many full-time firefighters work 24 hours on and 48 hours off. When they return to work, their gloves and boots are often still wet. Volunteer firefighters are on call 24 hours a day, seven days a week. They often respond to calls several days in a row most often wearing wet gloves and boots especially in the winter time.

Frequently a firefighter's boots and gloves are lined with a biohazard barrier which causes poor ventilation. This lack of ventilation often prevents the gloves and boots from drying. The moisture within the gloves and boots causes premature wear of these articles. Additionally, the moisture gives rise to mildew which can cause significant odors in the gloves and boots.

Wet gloves and boots can cause other problems as well. When firefighters enter a fire with wet gloves and boots, water steams and burns their hands or feet. In the winter, a person's skin gets cold 25 times faster when it is wet than when it is dry. Hence, wearing wet gloves and boots can cause frostbite too. Additionally, prolonged wearing wet boots will cause the firefighter's feet to blister and peel; thus, providing an ideal environment for fungus to grow.

The National Fire Protection Association, Inc. (NFPA) has established standards for drying gloves and boots. One such standard is NFPA 1851. NFPA 1851 is entitled “Selection, Care, and Maintenance of Structural Fire Fighting Protective Ensembles.” NFPA 1851 specifies that gloves must not be dried with heat and that footwear must be air dried. Moreover, NFPA 1851 specifies that ensembles or elements should be dried without heat, but if heat must be used, then the machine basket temperature should not exceed 40° C. (105° F.).

Some fire departments have a large air dryer located in the fire station where the fireman can dry their turn out gear off duty. However, these machines are often large and expensive. They are not convenient for firefighters because they must travel to another station on their own time. Moreover, firefighters find it inconvenient for use of gloves or boots when other clothes take higher priority.

Apparatus for drying garments are known. For example, U.S. Pat. No. 5,058,289 issued to Guindon on Oct. 22, 1991, discloses a device for drying garments. The device includes a base having a heating coil and a blower. An air plenum and an adapter are connected to the base. Flexible bellows tubes are connected to the adapter.

The Guindon device has several problems. First, this type of device cannot be used with a leather glove or boot because heated air adversely affects the size of the article. For example, heated air will cause a wet leather glove to shrink. Additionally, NFPA 1851 discourages the use of heat. Second, the flexible bellows tubes will not support the weight of a heavy boot such as that of fireman. Third, the device disclosed by Guindon only allows for the drying of a pair of articles.

Similarly, U.S. Pat. No. 5,412,928 issued Reithel on May 9, 1995 discloses a dehydration device consisting of a frame work and a mechanism for removing moisture from various garments and articles. The mechanism includes a manifold and an air forcing assembly attached to the side of the manifold. The air forcing assembly also includes a heater for heating the air.

The device disclosed by Reithel has several drawbacks. First, the device disclosed by Reithel is very expensive. Due to its expense, fire departments usually must share devices of the type disclosed by Reithel. Second, the device disclosed by Reithel is not portable and, thus, cannot be used in the field by fire personnel. Third, placement of the air forcing assembly on the side of the manifold adversely affects airflow.

There remains a need in the art for an apparatus for drying gloves and boots that is portable and capable of drying several pairs of gloves and boots.

### SUMMARY OF THE INVENTION

It is in view of the above problems that the present invention was developed. The invention is an apparatus for drying gloves and boots. The apparatus includes a pipe, a fan attached to one end of the pipe, several first tubes connected in a vertical direction to the pipe, and second tubes angularly connected to the first several tubes.

The apparatus includes a sufficient number of first and second tubes to allow for drying of several pairs of gloves and boots simultaneously.

The apparatus dries articles by providing cool air-flow within the article. The cool air does not harm bio-hazard linings.

The apparatus is portable such that it can be used indoors or out.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a perspective view of an apparatus for drying gloves and boots in the first embodiment;

FIG. 2 is a side view of an apparatus for drying gloves and boots in a second embodiment;

FIG. 3 is a sectional side view of the embodiment shown in FIG. 1.

### DETAILED DESCRIPTION OF THE PREFERRED EMBODIMENTS

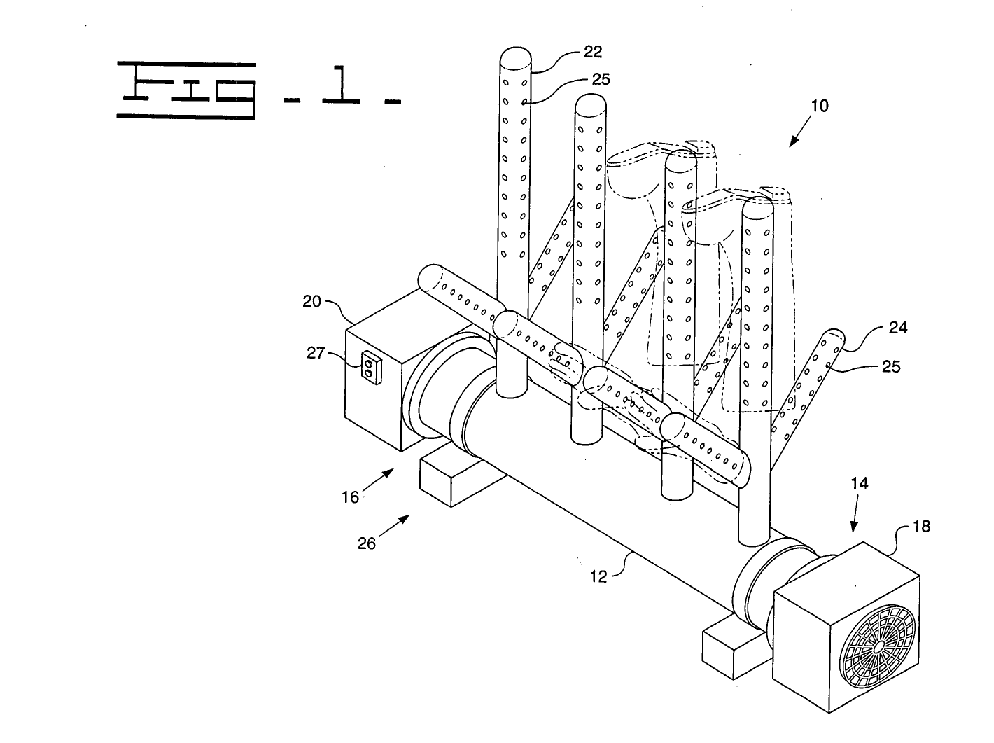

Referring to the accompanying drawings in which like reference numbers indicate like elements, FIG. 1 illustrates an apparatus for drying gloves and boots 10. In FIG. 1, drying gloves and boots are depicted in phantom. The apparatus 10 includes a pipe 12 having a first end 14 and a second end 16. In the depicted embodiment, the pipe 12 is made of plastic. A plastic pipe has the advantages of being lightweight and cost-effective. However, those skilled in the art will understand that the pipe 12 could be made of other materials, such as metal. A first fan 18 is attached to the first end 14 of the pipe 12. A second fan 20 is attached to the second end 16 of the pipe 12. The fans 18, 20 are roughly the same size as the diameter of the ends 14, 16 of the pipe 12. The fans 18, 20 may operate on alternating current or direct current. In the depicted embodiment, both fans 18, 20 move air towards a center of the pipe 12. However, those skilled in the art will understand that one of the fans 18, 20 could move air away from the center.

First tubes 22 are connected to the pipe 12. In the depicted embodiment of FIG. 1, the first tubes 22 are shown arranged connected in a perpendicular direction to an axis of the pipe 12. There are four first tubes 22 shown in FIG. 1. However, a greater or lesser number of first tubes 22 may be used. Second tubes 24 are operatively connected to the first tubes 22. The second tubes 24 are angularly connected to the first tubes 22. In the depicted embodiment of FIG. 1, the second tubes 24 are connected at an angle of 45° to the first tubes 22. Additionally in the depicted embodiment of FIG. 1, the first tubes 22 are longer than the second tubes 24. However, those skilled in the art will understand that first tubes 22 and second tubes 24 could be of the same length. There are eight second tubes 24 shown in FIG. 1. However, a greater or lesser number of second tubes 24 may be used. First and second tubes 22, 24 each include a plurality of holes 25. In some embodiments, a switch 27 may be included and electrically connected to the first and second fans 18, 20. Additionally, the pipe 12 may be connected to a base 26. The base 26 may be made of wood, metal, or plastic and merely supports the pipe 12. The arrangement of the pipe 12, the fans 18, 20, and the tubes 22, 24 allows the apparatus 10 to be compact and portable.

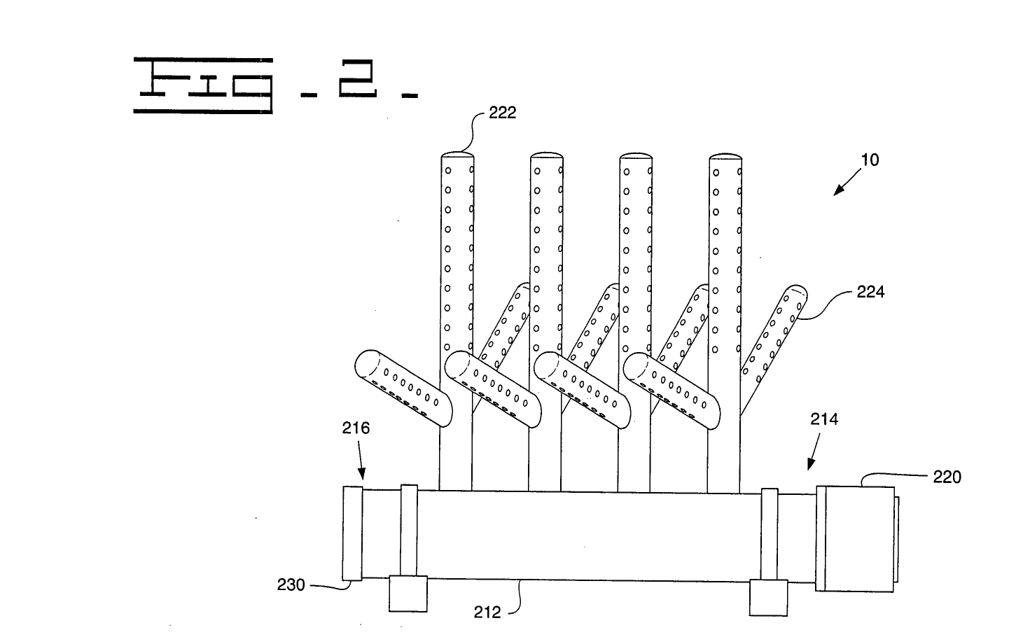

FIG. 2 illustrates a second embodiment of the apparatus for drying gloves and boots 10. This second embodiment includes only one fan 220 attached either at a first end 214 or a second end 216 of a pipe 212. A plug 230 is attached to whichever end of the pipe 212 that is not connected to the fan 220. The plug 230 caps the end of the pipe 212 such that air from the fan 220 is forced through a plurality of first tubes 222 and a plurality of second tubes 224.

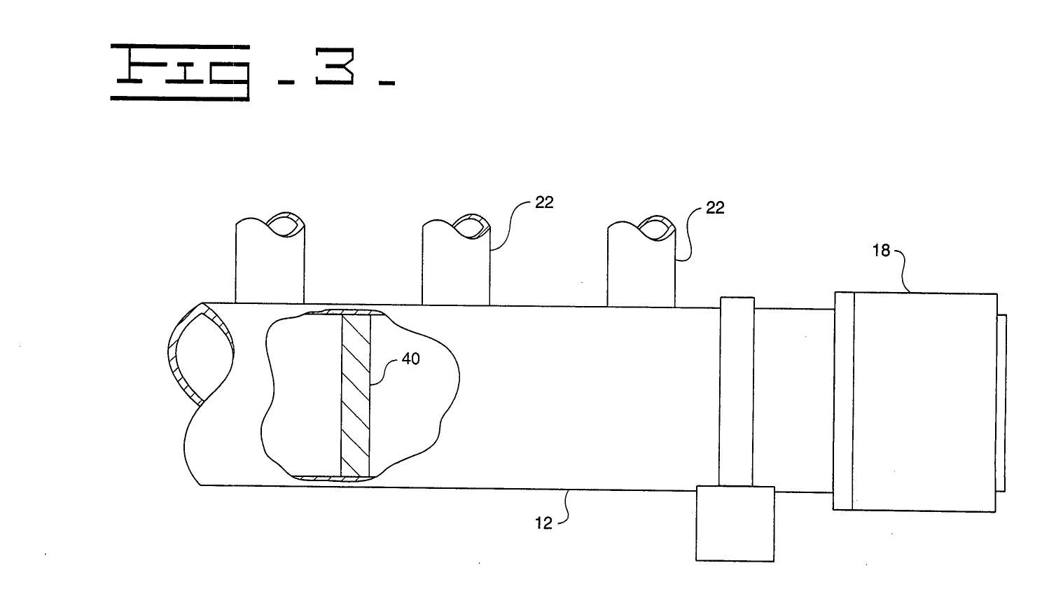

FIG. 3 illustrates a variation of the embodiment shown in FIG. 1. In FIG. 3, an insert 40 is inserted into the pipe 12 between the first and second fans 18,20. In the depicted embodiment of FIG. 3, the insert 40 is placed in the center of the pipe 12. In this case, each fan 18, 20 only feeds two of the first tubes 22.

In operation, a user (not shown) places at least one pair of boots and at least one other pair of gloves and/or boots on the respective first or second tubes 22, 24. The user connects the fans 18, 20 to electrical current. In some embodiments, the user operates the switch 27. The electrical current causes the fans 18, 20 to move air, and the fans 18, 20 force air into the pipe 12. The air travels through the pipe 12 parallel to the pipe's axis. The air flow changes direction and enters into the tubes 22, 24. The air then flows out the tubes 22, 24 through the holes 25 and into a glove and/or a boot. The air thereby assists in the rapid dehydration of the glove and/or boot.

### Method of Assembly

In a first step, fans 18, 20 are operatively connected to the pipe 12. First tubes 22 are operatively connected and perpendicular to the pipe 12 in a second step. In a third step, second tubes 24 are angularly connected to the first tubes 22. In an optional step, the fans 18, 20 are connected to the switch 27. In a further optional step, the base 26 is operatively connected to the pipe 12.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. For example, while only four first tubes are shown, a greater or lesser number of first tubes may be used. Thus, the breadth and scope of the present invention should not be limited by any of the above-described exemplary embodiments, but should be defined only in accordance with the following claims appended hereto and their equivalents.

1. An apparatus for drying gloves and boots comprising:
a pipe having a first end and a second end;
a fan attached to at least one of said first and second ends of said pipe, said fan being adapted to move air in a first direction and connected to a power source;
a plurality of first tubes operatively connected and perpendicular to said pipe, each of said plurality of first tubes having a plurality of holes and being adapted to move air in a second direction; and
at least one second tube angularly connected to at least one of said plurality of first tubes, said at least one second tube having a plurality of holes.

2. The apparatus of claim 1, wherein said pipe is plastic.

3. The apparatus of claim 1, wherein said power source is selected from the group consisting of an alternating current power source and a direct current power source.

4. The apparatus of claim 1, further comprising a plug attached to said pipe at an end opposite of said fan.

5. The apparatus of claim 1, wherein said plurality of first tubes are longer than said at least one second tube.

6. The apparatus of claim 1, wherein said plurality of first tubes and said at least one second tube are of the same length.

7. The apparatus of claim 1, wherein said at least one second tube is connected to at least one of said plurality of first tubes at an angle of forty-five degrees.

8. The apparatus of claim 1, further comprising a switch electrically connected to said fan.

9. The apparatus of claim 1, further comprising a base operatively connected to said pipe.

10. The apparatus of claim 1, wherein there are four of said first tubes and eight of said second tubes.

11. An apparatus for drying gloves and boots comprising:
a pipe having a first end and a second end;
a first fan attached to said first end of said pipe, said first fan being connected to a power source;
a second fan attached to said second end of said pipe, said second fan being connected to said power source;
a plurality of first tubes operatively connected and perpendicular to said pipe, each of said plurality of first tubes having a plurality of holes; and
at least one second tube angularly connected to at least one of said plurality of first tubes, said at least one second tube having a plurality of holes.

12. The apparatus of claim 11, wherein said pipe is plastic.

13. The apparatus of claim 11, wherein said power source is selected from the group consisting of an alternating current power source and a direct current power source.

14. The apparatus of claim 11, wherein said plurality of first tubes are longer than said at least one second tube.

15. The apparatus of claim 11, wherein said plurality of first tubes and said at least one second tube are of the same length.

16. The apparatus of claim 11, wherein said at least one second tube is connected to at least one of said plurality of first tubes at an angle of forty-five degrees.

17. The apparatus of claim 11, further comprising a switch electrically connected to said fan.

18. The apparatus of claim 11, further comprising a base operatively connected to said pipe.

19. The apparatus of claim 11, further comprising an insert operatively connected to said pipe.

20. The apparatus of claim 11, wherein there are four of said first tubes and eight of said second tubes.

21. A method of assembling an apparatus for drying gloves and boots comprising the steps of:
providing a pipe having two ends;
connecting a first fan to one of said ends;
connecting a second fan to one of said ends opposite said first fan;
connecting a plurality of first tubes perpendicular to said pipe; and
angularly connecting a plurality of second tubes to said first tubes.

22. The method of assembly of claim 21, further comprising the step of:
electrically connecting a switch to said first fan and said second fan.

23. The method of assembly of claim 21, further comprising the step of:
connecting a base to said pipe.
